(19) United States
(12) Patent Application Publication
(10) Pub. No.: US 2008/0297564 A1
(43) Pub. Date: Dec. 4, 2008

(54) INKJET PRINTHEAD

(75) Inventors: Yong-won Jeong, Seoul (KR); Hyung Choi, Seongnam-si (KR); Yong-seop Yoon, Seoul (KR); Moon-chul Lee, Yongin-si (KR); Dong-sik Shim, Suwon-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 11/935,539

(22) Filed: Nov. 6, 2007

(30) Foreign Application Priority Data
May 29, 2007 (KR) 2007-52216

(51) Int. Cl. B41J 2/14; B41J 2/04

(52) U.S. Cl. 347/47; 347/54

(57) ABSTRACT

An inkjet printhead includes a substrate in which an ink feed hole is formed, a plurality of ejection devices formed on the substrate at sides of the ink feed hole, a chamber layer stacked on the substrate and in which a plurality of ink chambers, which correspond to the ejection devices and in which ink supplied from the ink feed hole is filled, are formed, and a nozzle layer in which a plurality of nozzles corresponding to the ink chambers are formed, wherein the ink feed hole includes a plurality of through holes formed through the substrate in the thickness direction thereof.

### CROSS-REFERENCE TO RELATED APPLICATIONS

This application claims priority under 35 U.S.C. §119(a) Korean Patent Application No. 10-2007-0052216, filed on May 29, 2007 in the Korean Intellectual Property Office, the disclosure of which is incorporated herein in its entirety by reference.

### BACKGROUND OF THE INVENTION

1. Field of the Invention

The present general inventive concept relates to an inkjet printhead, and more particularly, to a thermal driving inkjet printhead having a robust and reliable structure.

2. Description of the Related Art

In general, an inkjet printer forms images of predetermined colors by ejecting minute ink droplets from an inkjet printhead onto desired parts of a print medium. Inkjet printers are classified into a shuttle type inkjet printer that prints using a printhead that reciprocally moves in a direction perpendicular to a transferring direction of a print medium and a line printing type inkjet printer that prints using an array printhead having a length corresponding to the width of a print medium. The line printing type inkjet printer is being developed to realize high speed printing. The array printhead includes a plurality of inkjet printheads arranged in a predetermined configuration. The line printing type inkjet printer performs a printing operation in a state where the array printhead is fixed and only a print medium is transferred. Thus, high speed printing can be realized.

Meanwhile, inkjet printheads can be classified into two types according to ink ejection mechanisms. The first type is a thermal driving inkjet printhead that generates bubbles in ink using a heat source, thereby ejecting ink droplets due to an expanding force of the bubbles. The second type is a piezoelectric driving printhead that ejects ink droplets using a pressure applied to ink due to deformation of a piezoelectric body.

The ink ejection mechanism of the thermal driving inkjet printhead can be described in more detail as follows. When a current in a form of a pulse flows through a heater formed of resistive heating elements, heat is generated in the heater and ink adjacent to the heater is almost instantaneously heated to about 300° C. Thus, ink is boiled and bubbles are generated, and the generated bubbles expand, and thus, a pressure is applied to the ink filled in an ink chamber. Accordingly, ink near a nozzle is ejected in the form of droplets through a nozzle to an outside of the ink chamber.

FIG. 1 is a schematic cross-sectional view illustrating a conventional thermal driving inkjet printhead. Referring to FIG. 1, the conventional thermal driving inkjet printhead includes a substrate 10, a chamber layer 20 stacked on the substrate 10, and a nozzle layer 30 stacked on the chamber layer 20. A plurality of ink chambers 22 in which ink to be ejected is filled are formed in the chamber layer 20, and a nozzle 32 through which ink is ejected is formed in the nozzle layer 30. Also, an ink feed hole 11 for supplying ink to the ink chambers 22 is formed through the substrate 10. Also, heaters 14 are formed on the substrate 10 to heat the ink in the ink chambers 22 to generate bubbles.

However, in the above described conventional thermal driving inkjet printhead, since the ink feed hole 11 is formed through the substrate 10, the substrate 10 may be fragile and thus may be easily deformed. Accordingly, the ink feed hole 11 may be deformed, and thus, the nozzle layer 30 stacked above the substrate 10 may also be deformed. In addition, during maintenance of the inkjet printhead, failure may be generated around the deformed nozzle layer 30 and ink may not be ejected to desired parts of a print medium. Such fragility of the inkjet printhead increases as the length of the inkjet printhead increases, and in a line printing type inkjet printer developed to realize high speed printing, the inkjet printhead may be even more fragile.

### SUMMARY OF THE INVENTION

The present general inventive concept provides a thermal driving inkjet printhead having a robust and reliable structure.

Additional aspects and utilities of the present general inventive concept will be set forth in part in the description which follows and, in part, will be obvious from the description, or may be learned by practice of the general inventive concept.

The foregoing and/or other aspects and utilities of the present general inventive concept may be achieved by providing an inkjet printhead, including a substrate in which an ink feed hole is formed, a plurality of ejection devices formed on the substrate at sides of the ink feed hole, a chamber layer stacked on the substrate and in which a plurality of ink chambers, which correspond to the ejection devices and in which ink supplied from the ink feed hole is filled, are formed, and a nozzle layer in which a plurality of nozzles corresponding to the ink chambers are formed, wherein the ink feed hole includes a plurality of through holes formed through the substrate in a thickness direction of the substrate.

Barrier ribs formed between the through holes may be formed of the same material as the substrate.

The cross-section of the through holes may be polygonal, hexagonal, or circular.

The foregoing and/or other aspects and utilities of the present general inventive concept may also be achieved by providing an inkjet printhead, including a substrate to define an ink supply passage, the ink supply passage including a plurality of through holes to supply an ink therethrough, and a plurality of barrier ribs to define the through holes, a chamber layer formed on the substrate to define a plurality of ink chambers, a nozzle layer to define a plurality of nozzles disposed to correspond with the ink chambers, and a plurality of ink ejection devices disposed in the chambers to eject an ink supplied to the ink chambers.

The ink supply passage may be formed in a thickness direction from a lower portion of the substrate toward an upper portion of the substrate to supply ink to the ink chambers.

The through holes may be formed by etching the substrate and a cross section of the through holes may be one of polygonal, hexagonal, and circular.

A diameter of the through holes may correspond to a diameter of the nozzles, such that the ink supply passage serves to filter the supplied ink.

The inkjet printhead may further include an insulation layer formed between the substrate and the chamber layer, wherein the plurality of ink ejection devices are formed on an upper surface of the insulation layer.

The insulation layer may define an upper portion of the ink supply passage wherein the through holes and barrier ribs are not formed.

The through holes may be formed through an entire thickness of the substrate.

The through holes may not be formed to correspond with an entire thickness of the substrate.

The inkjet printhead may further include a passivation layer and an anti-cavitation layer sequentially formed over the ink ejection devices.

The ink ejection devices may include one of a heater to heat the ink and eject ink through an expansion force of bubbles formed therein, and a piezoelectric device to eject ink through a deformation of the piezoelectric device.

### BRIEF DESCRIPTION OF THE DRAWINGS

The above and/or other aspects and utilities of the present general inventive concept will become apparent and more readily appreciated from the following description of the embodiments, taken in conjunction with the accompanying drawings of which:

FIG. 1 is a cross-sectional view illustrating a conventional thermal driving inkjet printhead;

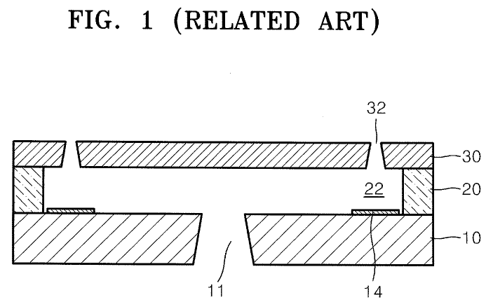

FIG. 2 is a schematic exploded perspective view illustrating an inkjet printhead according to an embodiment of the present general inventive concept; and

FIG. 3 is a cross-sectional view illustrating the inkjet printhead illustrated in FIG. 2 taken along line III-III′.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures. In the drawings, like reference numerals denote like elements, and the thicknesses of layers and regions are exaggerated for clarity. However, the embodiments described hereinafter are for the illustrative purposes only and the general inventive concept may be embodied in many different forms. For example, it will be understood that when a layer is referred to as being “on” another layer or substrate, it can be directly on the other layer or substrate, or intervening layers may also be present. In addition, elements of an inkjet printhead may be formed of other materials than the materials described herein.

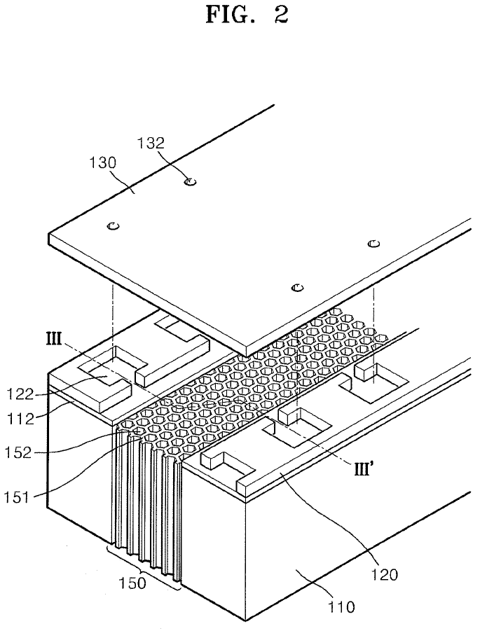

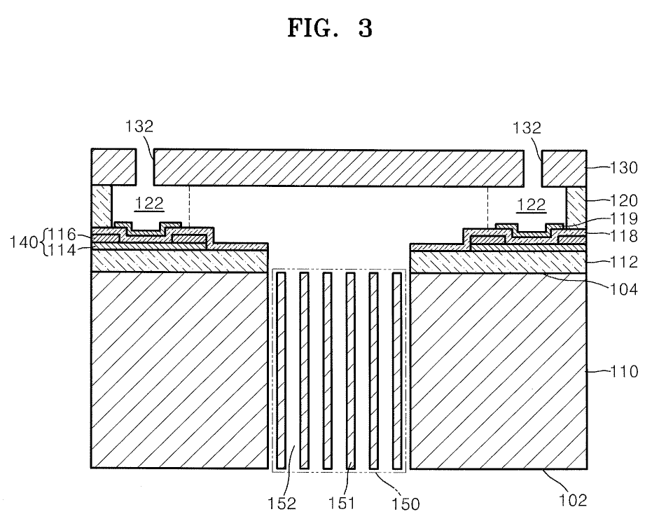

FIG. 2 is a schematic exploded perspective view illustrating an inkjet printhead according to an embodiment of the present general inventive concept; and FIG. 3 is a cross-sectional view illustrating the inkjet printhead illustrated in FIG. 2 taken along line III-III′.

Referring to FIGS. 2 and 3, the inkjet printhead may include a substrate 110 in which an ink feed hole 150 is formed, a plurality of ejection devices 140 formed on the substrate 110 at sides of the ink feed hole 150, a chamber layer 120 stacked on the substrate 110, and a nozzle layer 130 stacked on the chamber layer 120. A plurality of ink chambers 122 which correspond to the ejection devices 140 and in which ink supplied from the ink feed hole 150 is filled, are formed in the chamber layer 120. Here, each of the ejection devices 140 may include a heater 114 to heat the ink in the ink chamber 122 to generate bubbles and an electrode 116 to apply a current to the heater 114. Also, a plurality of nozzles 132, through which ink is ejected, are formed in the nozzle layer 130, corresponding to the ink chambers 122.

A silicon wafer may be generally used as the substrate 110. The ink feed hole 150 to supply ink to the ink chambers 122 via an upper portion of the substrate 110 from a lower portion of the substrate 110 is formed in the substrate 110. The ink feed hole 150 includes a plurality of through holes 152 that are formed through the substrate 110 in a thickness direction. That is, the thickness direction corresponds to a direction to supply ink from an ink reservoir (not illustrated) to the ink chambers 122. Here, barrier ribs 151 between the through holes 152 may be formed of the same material as the substrate 110. The through holes 152 may be formed by etching the substrate 110 such that the through holes 152 pass through the substrate 110 in the thickness direction. The through holes 152 can be formed from a lower surface 102 to an upper surface 104 of the substrate 110 through the entire thickness of the substrate 110.

When the through holes 152 are formed in the substrate 110 as described above, a robust ink feed hole 150 that has uniform width and is not easily deformed can be formed. Accordingly, deformation of the substrate 110 and the nozzle layer 130 that is stacked on the substrate 110 can be prevented, and damage of the nozzle layer 130 that may be generated during maintenance of the inkjet printhead can be prevented, thereby improving the ejection characteristics of the ink. Also, as a robust ink feed hole 150 which has a uniform thickness and is not easily deformed are formed, an amount and speed of ink supplied from the ink feed hole 150 to each of the ink chambers 122 can be made uniform, and thus the ejection characteristics of the nozzles 132 can also be made uniform. Also, since the barrier ribs 151 formed of the same material as the substrate 110, for example, silicon, may be formed in the ink feed hole 150, heat generated by the heater 114 can be rapidly dissipated not only through the substrate 110 but also through the barrier ribs 151 in the ink feed hole 150, thereby improving the ejection characteristics of ink included therein.

While in FIG. 2 the through holes 152 are illustrated as being formed in a honey comb form having a hexagonal cross-section, the form of the through holes 152 according to the present general inventive concept is not limited thereto, and the cross-section of the through holes 152 may have various shapes, for example the through holes 152 may be polygonal, such as tetragonal, pentagonal, etc., or circular.

An insulating layer 112 may be further formed on the upper surface 104 of the substrate 110. The insulating layer 112 serves to insulate between the substrate 110 and the heater 114, and may be formed of, for example, silicon oxide. Also, the heaters 114 can be formed on the upper surface of the insulating layer 112 to heat ink in the ink chambers 122 to generate bubbles. The heater 114 may be formed of a heat resistor, such as tantalum-aluminum alloy, tantalum nitride, titanium nitride, tungsten silicide, or the like. A plurality of electrodes 116 can be formed on the upper surfaces of the heater 114, formed of a highly conductive material, such as aluminum (Al), aluminum alloy, gold (Au), silver (Ag), etc. The heater 114 and the electrodes 116 constitute the ejection devices 140 as described above.

Meanwhile, a passivation layer 118 may be further formed on the upper surface of the heaters 114 and the electrodes 116. The passivation layer 118 serves to prevent oxidization or rusting of the heaters 114 and the electrodes 116 due to contact with ink, and may be formed of, for example, silicon nitride or silicon oxide. Also, an anti-cavitation layer 119 may be further formed on an upper surface of the passivation layer 118, which forms a bottom of the ink chambers 122, that is, may be formed on an upper surface of the passivation layer 118 disposed on heating portions of the heaters 114. The anti-cavitation layer 119 serves to protect the heaters 114 from a cavitation force that is generated when bubbles collapse, and may be formed of, for example, tantalum (Ta).

The chamber layer 120 is stacked above the substrate 110. A plurality of the ink chambers 122 in which ink supplied from the ink feed hole 150 is filled are formed in the chamber layer 120. The ink chambers 122 may be disposed above the heaters 114. The chamber layer 120 may be formed of, for example, polymer.

The nozzle layer 130 is stacked on the chamber layer 120. A plurality of the nozzles 132, through which ink of the ink chambers 122 is ejected out, are formed in the nozzle layer 130. Here, the nozzles 132 may be disposed above the ink chambers 122. The nozzle layer 130 may be formed of, for example, polymer.

As described above, the inkjet printhead according to the present general inventive concept has the following advantages:

First, as an ink feed hole includes a plurality of through holes formed by etching the substrate in the thickness direction, a robust ink feed hole that has a uniform width and is not easily deformed can be formed. Accordingly, deformation of the substrate and the nozzle layer stacked above the substrate can be prevented, and damage of the nozzle layer that may occur during maintenance of the inkjet printhead can be prevented, thereby improving the ejection characteristics of ink included therein.

Second, an amount and speed of ink supplied from the ink feed hole to each of the ink chambers can be made uniform such that the ejection characteristics between the nozzles are made uniform.

Third, since barrier ribs of the same material as the substrate, for example, of silicon, can be formed in the ink feed hole, heat generated by the heaters can be rapidly externally dissipated not only through the substrate but also through the barrier ribs in the ink feed hole. Accordingly, the temperature of the inkjet printhead which generally increases during ink ejection, can be reduced thereby improving the ejection characteristics of ink included therein.

Fourth, the through holes in the ink feed hole can also function as micro-filters. That is, if there is impurity in an ink cartridge that is combined to the inkjet printhead and supplies ink to the ink feed hole, the impurity can be filtered by the through holes formed in the ink feed hole, and thus pure ink without impurities can be filled in the ink chambers. Accordingly, ink ejection defects which may occur due to an impurity contained in the ink can be prevented.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. An inkjet printhead, comprising:
a substrate in which an ink feed hole is formed;
a plurality of ejection devices formed on the substrate at sides of the ink feed hole;
a chamber layer stacked on the substrate and in which a plurality of ink chambers, which correspond to the ejection devices and in which ink supplied from the ink feed hole is filled, are formed; and
a nozzle layer in which a plurality of nozzles corresponding to the ink chambers are formed,
wherein the ink feed hole includes a plurality of through holes formed through the substrate in a thickness direction of the substrate.

2. The inkjet printhead of claim 1, wherein barrier ribs formed between the through holes are formed of a same material as the substrate.

3. The inkjet printhead of claim 2, wherein the through holes are formed by etching the substrate such that the through holes are formed through the substrate in the thickness direction.

4. The inkjet printhead of claim 1, wherein the substrate is a silicon wafer.

5. The inkjet printhead of claim 1, wherein the cross-section of the through holes is polygonal.

6. The inkjet printhead of claim 5, wherein the cross-section of the through holes is hexagonal.

7. The inkjet printhead of claim 1, wherein the cross-section of the through holes is circular.

8. The inkjet printhead of claim 1, wherein an insulating layer is formed on an upper surface of the substrate.

9. The inkjet printhead of claim 8, wherein each of the ejection devices includes a heater which is formed on the insulating layer to heat ink in the ink chamber to generate bubbles in the ink and an electrode which is formed on the heater to apply a current to the heater.

10. The inkjet printhead of claim 9, wherein a passivation layer is further formed on a surface of the heaters and the electrodes.

11. The inkjet printhead of claim 10, wherein an anti-cavitation layer to protect the heaters from a cavitation pressure is further formed on the passivation layer disposed on the heaters.

12. An inkjet printhead, comprising:
a substrate to define an ink supply passage, the ink supply passage comprising:
a plurality of through holes to supply an ink therethrough, and
a plurality of barrier ribs to define the through holes;
a chamber layer formed on the substrate to define a plurality of ink chambers;
a nozzle layer to define a plurality of nozzles disposed to correspond with the ink chambers; and
a plurality of ink ejection devices disposed in the chambers to eject an ink supplied to the ink chambers.

13. The inkjet printhead of claim 12, wherein the ink supply passage is formed in a thickness direction from a lower portion of the substrate toward an upper portion of the substrate to supply ink to the ink chambers.

14. The inkjet printhead of claim 12, wherein the through holes are formed by etching the substrate and a cross section of the through holes is one of polygonal, hexagonal, and circular.

15. The inkjet printhead of claim 12, wherein a diameter of the through holes corresponds to a diameter of the nozzles, such that the ink supply passage serves to filter the supplied ink.

16. The inkjet printhead of claim 12, further comprising:
an insulation layer formed between the substrate and the chamber layer, wherein the plurality of ink ejection devices are formed on an upper surface of the insulation layer.

17. The inkjet printhead of claim 16, wherein the insulation layer defines an upper portion of the ink supply passage wherein the through holes and barrier ribs are not formed.

18. The inkjet printhead of claim 12, wherein the through holes are formed through an entire thickness of the substrate.

19. The inkjet printhead of claim 12, wherein the through holes are not formed to correspond with an entire thickness of the substrate.

20. The inkjet printhead of claim 12, further comprising a passivation layer and an anti-cavitation layer sequentially formed over the ink ejection devices.

21. The inkjet printhead of claim 12, wherein the ink ejection devices comprises one of:
a heater to heat the ink and eject ink through an expansion force of bubbles formed therein, and
a piezoelectric device to eject ink through a deformation of the piezoelectric device.
